(19) United States
(12) Patent Application Publication
(10) Pub. No.: US 2010/0099386 A1
(43) Pub. Date: Apr. 22, 2010

(54) METHOD AND APPARATUS FOR RADIO VOICE MAIL

(75) Inventor: Engelhard B. Sundoro, Overland Park, KS (US)

Correspondence Address: GARMIN LTD.;C/O GARMIN INTERNATIONAL, INC., ATTN: Legal - IP, 1200 EAST 151ST STREET, OLATHE, KS, 66062, US

(73) Assignee: GARMIN LTD., Camana Bay (KY)

(21) Appl. No.: 12/254,621

(22) Filed: Oct. 20, 2008

(51) Int. Cl. H04M 11/10; H04B 7/15

(52) U.S. Cl. 455/413; 455/11.1

(57) ABSTRACT

A marine radio comprises a memory for storing a message, in particular, a voice mail message, suitable for transmission to a second marine radio, a communication device for transmitting and receiving radio communications and a controller coupled to the memory and communication device. The controller is operable to cause the communication device to poll the second marine radio (e.g., by initiating a DSC individual call). When in range, the second marine radio may receive and acknowledge the poll. Upon receiving acknowledgement from the second marine radio, the controller causes the communication device to transmit the stored message to the second marine radio

### BACKGROUND

Marine radios, which operate in the VHF frequency range between 156 to 174 MHz, have been employed by all ships and many motorized small water craft for many years. These radios typically include a transmitter and receiver operating on standard, international frequencies known as channels. Transmission power of the transceivers typically ranges between 1 and 25 watts, providing the radios with a maximum range of up to about 60 nautical miles (111 km) between antennas mounted on large ships and ground stations, and about 5 nautical miles (9 km) between antennas mounted on small watercraft near sea-level.

Many marine radios are equipped to provide Digital Selective Calling (DSC). DSC is used to establish initial contact between marine radios. Marine radios equipped to provide DSC are assigned a unique identifier called a Maritime Mobile Service Identity (MMSI) number consisting of a series of nine digits. The MMSI is used to uniquely identify the radio to other radios. In this manner, DSC calls can be directed to specific marine radios on individual vessels or groups of vessels.

Presently, in order to initiate communication using DSC, a DSC call is made to another radio. The operator of the calling marine radio may monitor the radio for response from the operator of the called radio. Consequently, while attempting to initiate a communication using the marine radio, the operator is not free to pursue other tasks. Further, if the operator of the called radio is not monitoring his or her radio at the time the DSC call is received, communication between the radios cannot be established.

### SUMMARY

Techniques are described for transmitting and receiving recorded messages, in particular, recorded voice mail messages, between marine radios. In implementations, a voice mail message is stored in a memory of a first marine radio. The radio then polls a second marine radio (or group of marine radios) to which the message is to be delivered. When in range, the second marine radio may receive and acknowledge the poll to the first radio. Upon receiving acknowledgment of the poll, the first marine radio transmits the stored voice mail message to a second marine radio. In one or more embodiments, the first marine radio may be a marine VHF radio which initiates a DSC individual call to a second marine VHF radio. The second marine VHF radio may then receive and acknowledge receipt of the DSC individual call. If the DSC individual call is acknowledged, the marine VHF radios may negotiate a channel on which the message is to be delivered. Once a suitable channel is selected, the first marine VHF radio may then transmit the stored voice mail message to the second VHF marine radio on the selected (agreed) channel.

This Summary is provided solely as an introduction to subject matter that is fully described in the Detailed Description and Drawings. Accordingly, the Summary should not be considered to describe essential features nor be used to determine the scope of the Claims.

### BRIEF DESCRIPTION OF THE DRAWING FIGURES

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example environment in which techniques for transmitting and receiving prerecorded messages between marine radios may be employed.

FIG. 2 is an illustration of an exemplary implementation of marine radios in the environment of FIG. 1 in greater detail.

FIG. 3 is an illustration of an exemplary marine radio in the implementation of FIG. 2.

FIG. 4 is a flow diagram depicting an exemplary procedure in which a message is transmitted between marine radios.

FIG. 5 is a flow diagram depicting an exemplary procedure in which a message is received and acknowledged by a marine radio.

The drawing figures do not limit the present invention to the specific embodiments disclosed and described herein. The drawings are not necessarily to scale, emphasis instead being placed upon clearly illustrating the principles of the invention.

### DETAILED DESCRIPTION

### Overview

Techniques and processes are described for transmitting and receiving a recorded message, in particular, a recorded voice mail message, between two or more marine radios. In implementations, a message such as a voice mail message (or a text message, a video message, a data transmission, etc.) is stored in a memory of a first marine radio. The radio then polls a second marine radio (or group of marine radios) to which the message is to be delivered. When in range, the second marine radio may receive and acknowledge the poll to the first radio. Upon receiving acknowledgment of the poll, the first marine radio transmits the stored voice mail message to a second marine radio.

In one or more embodiments where the marine radios are marine VHF radios equipped to provide Digital Selective Calling (DSC), the first marine radio may initiate a DSC individual call to the second marine VHF radio (or group of marine VHF radios). The second marine VHF radio may then receive and acknowledge receipt of the DSC individual call. If the DSC individual call is acknowledged, the marine VHF radios may negotiate an appropriate channel on which the message is to be delivered. The negotiation between the VHF radios may include the first marine VHF radio suggesting a channel and the second marine VHF radio agreeing to, or rejecting, the suggested channel Thus, in some embodiments, the negotiation between the VHF radios may be limited to the second marine VHF radio agreeing to, or rejecting, the channel suggested by the first marine VHF radio. Once a suitable channel is selected (i.e., agreed to), the first marine VHF radio may then transmit the stored voice mail message to the second VHF marine radio on the selected channel.

In the following discussion, an example environment is first described that is operable to employ techniques and processes for transmitting and receiving recorded messages between marine radios as discussed herein. Example processes are then described which may be employed in the exemplary environment, as well as in other environments without departing from the spirit and scope thereof. Although the techniques and processes for transmitting and receiving recorded messages between marine radios are described in relation to a marine radio environment, it should be readily apparent that these techniques may be employed in a variety of different radio environments.

### Example Environment

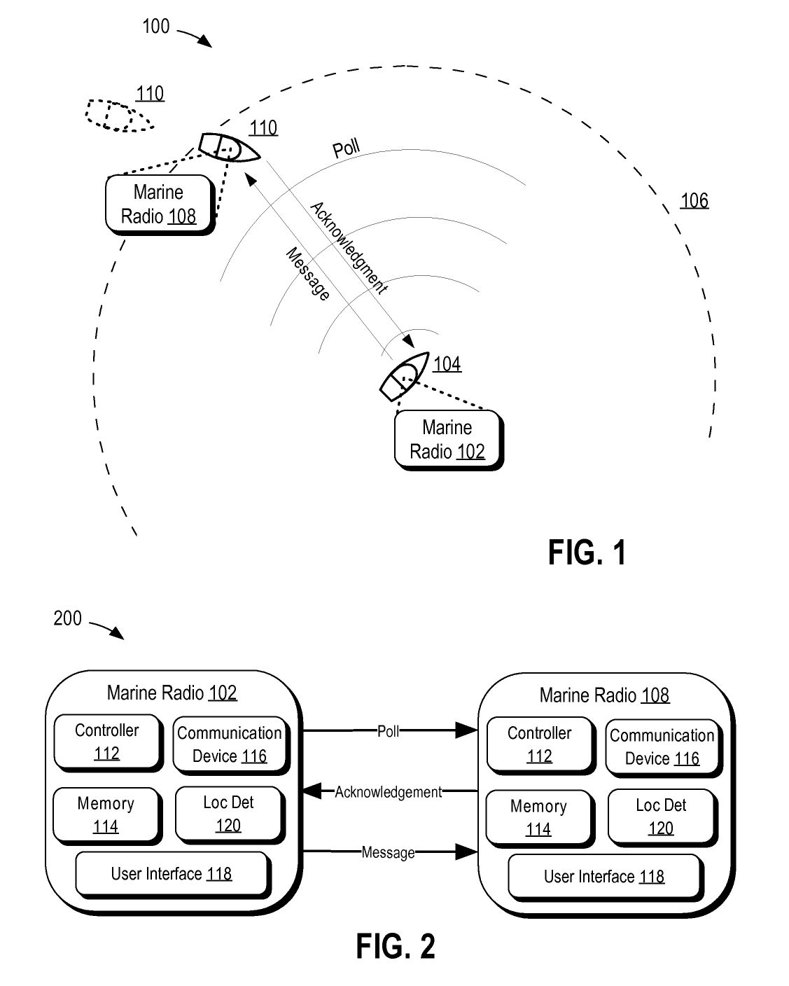

FIG. 1 depicts an example environment 100 in which techniques for transmitting and receiving messages between marine radios may be employed. In the example depicted, the environment 100 includes a first marine radio 102 associated with a first vessel 104 (such as a ship, a boat, or other watercraft), or located on shore at a ground station. As shown, the marine radio 102 may communicate with other marine radios which are, or travel, within the range 106 of its transmitter (e.g., a second marine radio 108 mounted to a second vessel 110 (as depicted), a second marine radio located on shore at a second ground station, and so on) via radio frequency communication. In implementations, the marine radios 102 & 108 may be VHF radios having transmitters which operate in the VHF frequency range, between about 156 to 174 MHz. As noted, the transmission power of the transmitters of marine VHF radios typically ranges between 1 and 25 watts, giving a maximum range 106 of about 5 nautical miles (9 km) between antennas mounted on small boats at or near sea-level. However, the maximum range 106 of the transmitter may be increased to about 60 nautical miles (111 km) or more between antennas mounted well above sea-level such as on large ships or at ground stations. It will be appreciated that the range of the marine radios 102 & 108 can vary, depending on factors such as transmission power, antenna placement, atmospheric conditions, and so forth.

The first marine radio 102 may transmit a stored voice mail message to a second marine radio 108 (or group of marine radios). The voice mail message is stored in memory of the first marine radio 102 by the operator of the radio. The first marine radio 102 then polls the second marine radio 108, for example, by initiating one or more DSC individual calls to the second marine radio 108.

Upon receiving the poll (e.g., upon receiving a DSC individual call) from the first marine radio 102, the second marine radio 108 transmits an acknowledgment of the poll. For example, the second marine radio 108 may transmit a reply DSC individual call to the first marine radio 102 acknowledging the poll. The marine radios 102 & 108 may then negotiate the channel on which the stored voice mail message is to be delivered, such as by radio 102 suggesting a channel and radio 108 agreeing to, or rejecting, the suggested channel, The first marine radio 102 then transmits the stored voice mail message to the second marine radio 108 on the selected channel.

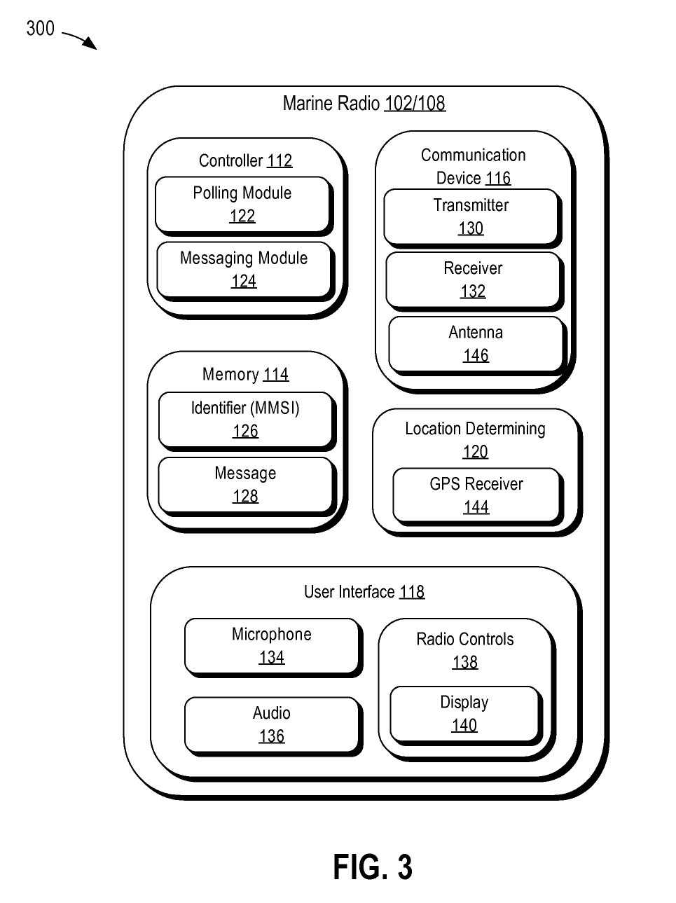

FIG. 2 illustrates an example implementation of the marine radios 102/108 of the environment of FIG. 1 in greater detail. FIG. 3 depicts an exemplary marine radio 102/108 of the implementation depicted in FIG. 2. Each marine radio 102/108 may include a controller 112, memory 114, a communication device 116 and a user interface 118. The marine radios 102/08 may further include functionality for determining position. For example, one or both of the marine radios 102/108 depicted in FIGS. 2 and 3 may include or be coupled to a location determining component 120 such as a Global Navigation Satellite System (GNSS) receiver, a terrestrial navigation system receiver (e.g., a Long Range Navigation (LORAN) receiver), and so forth.

The controller 112 provides control and processing functionality for the marine radio 102/108 and may include any number of processors, micro-controllers, or other processing systems and resident or external memory for storing data and other information accessed and/or generated by the marine radio 102/108. The controller 112 may execute one or more software programs which implement techniques and processes for causing the marine radio 102/108 to transmit and/or receive a voice mail message as described herein. The controller 112 is not limited by the materials from which it is formed or the processing mechanisms employed therein, and as such, may be implemented via semiconductor(s) and/or transistors (e.g., electronic integrated circuits (ICs)), and so forth.

As shown in FIG. 3, the controller 112 may implement a polling module 122 and a messaging module 124. The polling module 122 represents functionality for polling the second marine radio 108 (or multiple marine radios 108). In one or more embodiments, the polling module 122 may include timing functionality for repeating the poll. For instance, the polling module 122 may initiate a poll periodically (e.g., every 5 minutes) or randomly by varying times between initiated polls within a predetermined tolerance (e.g., 1 to 30 minutes). The polling module 122 may further include functionality to discontinue polling should the second radio 108 fail to acknowledge the poll. For instance, the polling module 122 may cause polling to time out after a period of time or a pre-determined number of polls if no acknowledgment is received. In embodiments, this time-out period may be fixed at a predetermined interval or number of polls, or may be variable (e.g., set by a user of the marine radio 102, selected by the controller 112 based on predefined conditions, etc.).

In marine VHF radio embodiments employing DSC, the polling module 122 may represent functionality for causing the first marine radio 102 to initiate one or more DSC individual calls to the second marine radio 108. DSC is a semi-automated paging system established by the International maritime Organization (IMO) which is used for initiating a radio call between marine radios. As presently implemented, DSC uses a digital signal to send information, which may include the calling radio's Maritime Mobile Service Identity (MMSI); the MMSI of the radio being called (the MMSI can be for a specific radio or a group of radios); the calling radio's location and time of location; the requested working channel (frequency and mode); the priority of the call (Distress, Urgent, Safety, Routine), and so on. It is contemplated that the DSC individual call can be addressed to a specific radio or set of radios. For example, the DSC call may be addressed to a specific vessel or shore station; all marine radios in a specific geographic area; a specific set of radios; all receivers in radio range, and so on.

The polling module 122 may further provide functionality for allowing the user to select or input an identifier for the marine radio (or group of marine radios) 108 to be polled. For example, in marine VHF radio embodiments employing DSC the polling module 122 may allow an operator to input the MMSI of a marine radio (or group of marine radios) 108 to be polled via the user interface 118, or to retrieve the MMSI of the marine radio 108 (or group of marine radios 108) to be polled from memory 114.

The polling module 122 may additionally represent functionality for causing the transmission of an acknowledgment by a marine radio 108 to a poll received another marine radio, and optionally to negotiate the selection of a channel for transmission of the stored message by other marine radio. For example, in marine VHF radio embodiments using DSC, when a marine radio 108 receives a DSC individual call, the polling module 122 of the radio 108 may obtain the MMSI of the marine radio 102 transmitting the DSC call and the MMSI(s) of the marine radio(s) being polled. When a DSC call is received, the polling module 122 of the marine radio 108 may use the DSC protocol to acknowledge the call and move to a working channel (i.e., to a different frequency and mode) to complete the call so that the message may be transmitted. According to current convention promulgated by the IMO, DSC uses channel 70 to place and receive DSC calls (e.g., 156.525 MHz).

The messaging module 124 represents functionality for receiving and storing the message that is transmitted by the marine radio 102, and for recalling the stored message from memory 128 and transmitting the message to a second marine radio 108. For example, the messaging module 124 may facilitate the recording of a voice mail message by the operator using the user interface 118, whereupon, the voice mail message is stored to memory 128 for transmission to the called marine radio 108. The messaging module 124 may also provide functionality for receiving the transmitted message from a second marine radio, storing the received message in memory 128, notifying an operator of the marine radio 108 of the stored message, retrieving the message from memory 114, repeating previously received messages (e.g., repeating any audio received within the last 30 seconds or another time period), and/or initiating playback of the message to the operator by the user interface 118 (e.g., via the audio device 136).

The memory 114 provides storage functionality for storing various data associated with operation of the marine radio 102/108, such as the software program and code segments mentioned above, or other data for instructing the controller 112 and other device elements to perform the steps described herein. Further, in implementations where the marine radio 102/108 includes or is coupled to a location determining component 120, the memory 114 may store various cartographic data corresponding to geographic locations including map data, and map elements, alert locations, points of interest, geographic entities, and other navigation data as required by the marine radio 102/108.

Although a single memory 114 is shown, a wide variety of types and combinations of memory may be employed. The memory 114 may be integral with the controller 112, stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth. In embodiments, the memory 114 may include removable ICC (Integrated Circuit Card) memory such as provided by SIM (Subscriber Identity Module) cards, USIM (Universal Subscriber Identity Module) cards, UICC (Universal Integrated Circuit Cards), and so on.

As shown in FIG. 3, the memory 114 may include memory for storing one or more identifiers such as MMSI 126. MMSIs are alphanumeric identifiers, which are used to uniquely identify the marine radio 102/108 to other marine radios. In this manner, DSC calls can be directed to specific marine radios on individual vessels or groups of vessels. MMSIs are formed of a series of nine digits which are used to uniquely identify ship stations, ship earth stations, coast stations, coast earth stations, and group calls. MMSIs may be prerecorded or entered via the user interface 118 for storage in the memory 114. In some embodiments, the memory 114 may include an address book of contacts (e.g., businesses, friends, authorities, vessels, and the like) and associated MMSIs.

The memory 114 may further include message memory 128 for storing one or more messages such as voice mail messages. For example, the message memory 128 may provide storage of one or more short voice mail messages recorded by an operator of the marine radio 102 for transmission to a second marine radio 108. Likewise, the message memory 128 may provide storage of one or more short voice mail messages received by the marine radio 108 from a sending marine radio 102. The stored voice mail messages may include user-generated messages and previously-generated default messages for transmission to other radios.

Voice mail messages may be recorded to the message memory 128 in digitized natural human voice. For instance, depending on specific application requirements, voice mail messages may be stored to message memory 128 in a conventional format (.WAV, .MP3, .MP4, etc.) or may be stored in a unique format developed specifically for the application. Further, to conserve memory space, the messages may be compressed using any suitable data compression technique. In embodiments, one or more voice mail messages may be recorded by the operator of the marine radio 102 using the user interface 118 (e.g., via the microphone 134) and stored to the message memory 128. The recorded messages may be any length limited only by the amount of memory 128 provided for storage of messages. However, in some embodiments, the length of messages recorded by the operator may be limited (e.g., 30 sec, 60 sec, 5 min, etc.). This limitation on message length may be preprogrammed or pre-selected by the operator during setup of the voicemail functionality in the radio 102/108.

The communication device 116 provides functionality for communicating with other marine radios 102/108 via wireless radio frequency communications. As shown in FIG. 3, the communication device 116 may include a combined transmitter 130 and receiver 132 that operate on standard, international frequencies known as channels. The communication device 116 may use “simplex” transmission, where communication can only take place in one direction at a time. During simplex transmission, a manual control such as a transmit button mounted to the microphone 134, the controller 112 executing a suitable software program, or similar method may be used to determine whether the transmitter 130 or receiver 132 is operated. The communication device 116 may also employ “duplex” transmission, where communication can take place in both directions simultaneously. In marine VHF radio embodiments, the transmitter 130 and receiver 132 may operate in the VHF frequency range, between about 156 to 174 MHz. In such implementations, transmission power of the transmitter 130 may range between about 1 and 25 watts. The transmitter 130 and receiver 132 may utilize frequency modulation. Further, in some embodiments the transmitter 130 and receiver 132 may be integrated to function as a transceiver.

The user interface 118 may include a microphone 134, an audio device 136 and radio controls 138 suitable for operation and control of the marine radio 102/108.

The microphone 134 may be a hand-held microphone of the type commonly used in marine radio applications and may be coupled to the marine VHF radio via wired or wireless connection. The microphone 134 may be equipped with a transmit button (push-to-talk switch) to switch between the transmitter 130 and receiver 132 during simplex communications. The microphone 134 may be used by the operator of the marine radio 102 to record a voice mail message to memory 128 for transmission to a second marine radio 108 as described herein.

The audio device 136 may include any sound amplification apparatus commonly used by marine radios (e.g., an amplifier/speaker arrangement, and so on). Alternatively or additionally, the audio device 136 may include apparatus (e.g., wiring, amplifiers, equalizers, connectors, etc.) to facilitate the connection of the marine radio 102/108 to an external sound amplification system within the vessel or ground station. The audio device 136 may be used by the operator of the marine radio 108 for playback of received voice mail messages as described herein.

The radio controls 138 function to allow the user to operate and control the marine radio 102/108 for transmission and receipt of communications with other marine radios 108/102. The radio controls 138 may include controls of the type commonly used for the operation and control of a marine radio. For instance, the radio controls 138 may include a power (On/Off) switch, a volume control, a squelch control, a keypad, controls for providing channel selection, controls for initiating a DSC individual call, controls for initiating an automated distress call, controls for the entry and optionally the storage to memory 114 and recall from memory 114 of one or more identifiers (e.g., MMSI), and so forth. Additionally, the radio controls 138 may further include a display 140 for displaying information (e.g., the channel selected, MMSIs optionally, cross-referenced with identities of the operators of the marine radios associated with the MMSIs, volume, etc.) to the operator of the marine radio 102/108. In embodiments, the display 140 may be an LCD (Liquid Crystal Diode) display, a TFT (Thin Film Transistor) LCD display, an LEP (Light Emitting Polymer or PLED (Polymer Light Emitting Diode) display, and so forth, capable of displaying text and, optionally, graphical information. The display 140 may be backlit via a backlight such that it may be viewed in the dark or other low-light environments. In specific implementations, the display 140 may be provided with a touch sensitive overlay allowing for further entry of data and commands In one or more embodiments, the display 140 may provide an indication that the marine radio 102 is polling other radios, that a voice mail message has been received by the marine radio 108 and is stored in memory 128, and so on.

In embodiments, the audio device 136, radio controls 138 (optionally including the display 140) may be integrated with the marine radio 102/108 and positioned on a front face of the radio's housing for ease of use, while the microphone 134 is provided as a separate hand-held “fist” microphone. In other embodiments, microphone 134, audio device 136, radio controls 138 (optionally including the display 140) may be integrated into a separate handset which is coupled to the marine radio 102/108 via a wired or wireless connection.

In some implementations, the marine radio 102/108 may include or be coupled to a location determining component 120 for determining the position of the vessel 104/110 (and marine radio 102/108) thereby allowing the position of the radio 102/108 to be provided in radio communications. In embodiments, the location determining component 120 may be a receiver suitable for use with a Global Navigation Satellite system (GNSS) or any other device which can determine locations of the marine VHF radio 102/108. For example, the location determining component 120 may be a global positioning system (GPS) receiver 144 operable to receive navigational signals from GPS satellites to calculate a position of the marine radio 102/108 as a function of the signals. The location determining component 120 may include one or more processors, controllers, or other processing systems and memory or may utilize the components of the controller 112. In embodiments, the memory of the processing system and/or the location determining component may store cartographic data and routing used by or generated by the location determining component. The memory may be integral with the location determining component, integral with the controller 112, stand-alone memory, or a combination of both. The memory may include, for example, removable and non-removable memory elements such as RAM, ROM, flash and/or other conventional memory elements.

The antenna 146 may be configured and strategically mounted and positioned to optimize the transmission and reception of radio frequency signals by the marine radio 102/108 to facilitate communication between radios.

In embodiments, marine radios 102/108 may have various mechanical and electrical configurations. For example, a marine radio 102/108 may be configured a stand-alone device wherein all components are contained in a single housing or case which utilizes either a fist microphone or an integrated handset as described herein. Alternatively, or additionally, certain components or combinations of components such as the microphone 134, audio device 136, location determining component 120, may be interconnected via a network such as an NMEA 2000 marine network.

### Example Procedures

The following discussion describes procedures for transmitting and receiving a recorded message, in particular, a recorded voice mail message, between two or more marine radios that may be implemented utilizing the previously described devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference may be made to the environment 100 of FIG. 1 and the example marine VHF radios 102/108 of FIGS. 2 and 3.

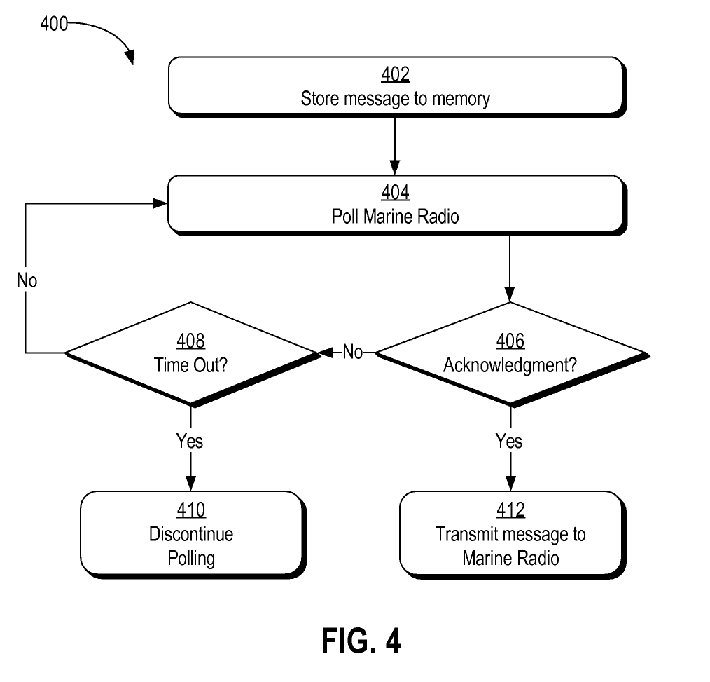

FIG. 4 depicts an exemplary procedure 400 in which a recorded message, in particular, a recorded voice mail message, is transmitted by a marine radio. A message is first stored to memory (block 402). For instance, an operator of a marine radio 102 may use the radio controls 138 to select a voice mail feature provided by the marine radio 102. The controller 112 (messaging module 124) may then cause the audio device 136 and/or the display 140 to provide prompts or other suitable guidance to guide the operator in recording the message. The operator may speak into the microphone 134 (as prompted) to record a voice message which the controller 112 causes to be stored in the message memory 128 as a voice mail message for transmission to a second marine radio 108. The voice mail message may be stored to message memory 114 in a conventional format (.WAV, .MP3, .MP4, etc.) or may be stored in a specific format as described. Further, to conserve memory space, the messages may be compressed using any suitable data compression technique.

The length of voice mail messages recorded by the operator may be limited (e.g., 30 sec, 60 sec, 5 min, etc.). In such embodiments, the controller 112 may cause the audio device 136 and/or the display 140 to prompt the operator that the voice mail message has exceeded the allowed length. Similarly, should the message memory 128 become full, the controller 112 may cause the audio device 136 and/or the display 140 to prompt the operator that the length and/or number of messages stored in the message memory 128 has exceeded the amount of memory available. The operator may then delete old messages as desired.

The marine radio may then poll for the marine radio(s) for which the voice mail message is intended (block 404). In embodiments, the operator may enter or select, via the user interface 118, one or more identifiers such as MMSI corresponding to a second marine radio 108 (or group of marine radios 108) to which the voice mail message is to be sent. The controller 112 (polling module 122) of the first marine radio 102 may then cause the communication device 116 to poll for the second marine radio 108 (or group of radios 108) identified by the identifier(s). More specifically, the polling module 122 may initiate DSC individual calls to the marine radio(s) 108 identified by the entered/selected MMSI.

A determination is next made whether the polled marine radio(s) 108 have acknowledged the poll (e.g., DSC individual call) (block 406). If no acknowledgement is received, the polling module 122 may continue polling (initiating DSC individual calls) until acknowledgement is received from the second marine radio 108 (or, optionally, all or some portion of the marine radios 108 within a group being polled). Should the second marine radio(s) fail to acknowledge the poll, polling may time out (block 408) and be discontinued (block 410). For example, the polling module 122 may discontinue polling should the second radio 108 fail to acknowledge the poll (DSC individual calls). The polling module 122 may cause polling to time out after a period of time, number of polls, and so on, if no acknowledgment is received. Alternatively, no time out may be utilized and polling may be allowed to continue until the operator manually causes (e.g., via the user interface 118) the marine radio 102 to discontinue polling. In embodiments, the polling module 122 may initiate the poll (DSC individual call) periodically such as, for example, every 5 minutes, or randomly, for example, at varying times between initiated polls within a predetermined tolerance (e.g., 5 to 6 minutes).

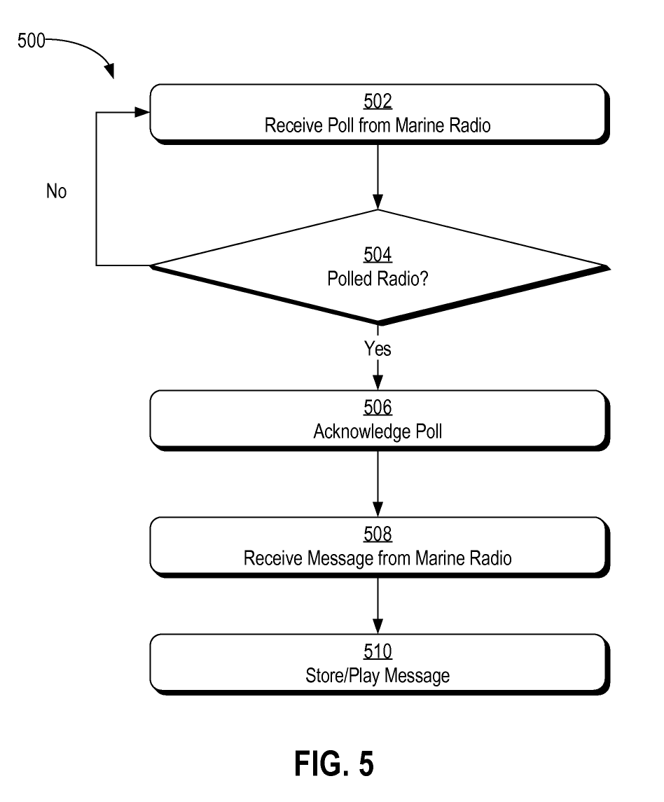

If an acknowledgment of the poll (DSC individual call) is received (block 406) the voice mail message is transmitted to the polled marine radio (block 412). In embodiments, the polling modules 122 of the marine radios 102 and 108 may negotiate the selection of a channel for transmission of the stored message between the radios 102 and 108 as described in the discussion of FIG. 5 below. Once the message is transmitted, the controller 112 may cause an alert to be provided to the operator of the marine radio 102 that the message has been successfully transmitted (e.g., via a prompt displayed by display 140, an audio prompt by audio device 136, a light, etc.).

FIG. 5 depicts an exemplary procedure in which a recorded message, in particular, a recorded voice mail message, is received by a marine radio. A poll such as the poll (DSC individual call) described in block 404 of FIG. 4 is received from a second marine VHF radio (block 502). If it is determined that the poll is meant for a third marine radio (and not the receiving marine radio 108) it is ignored (block 504). However, if the poll is directed to the marine radio receiving the poll (block 504), the poll is acknowledged by the marine VHF radio (block 506). For example, in the embodiment illustrated in FIGS. 1 through 3, the polling module 122 of the called marine radio 108 may cause the radio's communication device 116 to transmit an acknowledgment to the polling marine radio 102, and optionally may negotiate the selection of a channel for transmission of the stored message between the polling marine radio 102 and the called marine radio 108.

For example, in marine VHF radio implementations using DSC, when the marine radio 108 receives a DSC individual call, the polling module 122 of the radio's controller 112 receives the MMSI of the polling marine radio 102 and the MMSI(s) of the marine radio(s) for which the message is intended. The polling module 122 may employ DSC protocol to acknowledge the call and move to a working channel to complete the call so that the message may be transmitted.

After acknowledging the poll, the marine radio may then receive the message from the polling marine radio (block 508). The messaging module 124 of the marine radio 108 may receive the transmitted voice mail message on the negotiated channel. The received message may then be played for the operator and/or, optionally, stored for later playback to the operator (block 510). For example, in embodiments, the controller 112 of the marine radio 108 may cause the voice mail message received by the marine radio 108 to be stored in the message memory 128 for playback to the operator. The operator may then cause the message to be played back immediately upon receipt or at a later time selected by the operator. Thus, the operator may choose to play back two or more voice mail messages at a time when it is convenient for the operator to listen to the messages.

### Example

Alice and Bob decide to go fishing off the Marquesas Keys on Saturday. Alice arrives to the Keys in her boat first and locates an ideal fishing spot. Using marine radio 102, Alice records a voice message for Bob stating her location and the fishing conditions. Alice then begins fishing while marine radio 102 polls marine radio 108 (Bob's radio) without further involvement from Alice. As Bob enters the transmission range of marine radio 102, his marine radio 108 receives the poll from Alice's marine radio 102 and (optionally) negotiates an appropriate radio channel Alice's voice message is transmitted to Bob's marine radio 108 and audibly played for Boball while Alice concentrates on fishing and not manning her radio.

This Example is provided solely as one example use of embodiments of the present invention. Accordingly, the Example should not be considered to describe essential features of the invention nor be used to determine the scope of the Claims.

### CONCLUSION

Although the invention has been described with reference to exemplary embodiments illustrated in the attached drawing figures, it is noted that equivalents may be employed and substitutions made herein without departing from the scope of the invention as recited in the claims. Further, the marine radio 102/108 and its components illustrated and described herein are merely examples of a device and components that may be used to implement the present invention and may be replaced with other devices and components without departing from the scope of the present invention.

What is claimed is:

1. A radio, comprising:
a memory for storing a message suitable for transmission to a second radio;
a communication device for transmitting and receiving radio communications; and
a controller coupled to the memory and communication device, the controller being operable to cause the communication device to poll the second radio and to transmit the stored message to the second radio upon receiving an acknowledgement from the second radio to the poll.

2. The radio as claimed in claim 1, wherein the message comprises a voice mail message.

3. The radio as claimed in claim 2, further comprising a user interface for receiving a voice message, the controller being operable for storing the voice message to the memory as the voice mail message.

4. The radio as claimed in claim 1, wherein the second radio comprises a marine VHF radio and the controller causes the communication device to poll the marine VHF radio by initiating a DSC individual call.

5. The radio as claimed in claim 4, further comprising a user interface for receiving the input of a Maritime Mobile Service Identity number for identifying the marine VHF radio.

6. The radio as claimed in claim 1, wherein the controller causes the communication device to poll of the second radio periodically.

7. The radio as claimed in claim 1, wherein the controller causes the communication device to poll the second radio randomly.

8. The radio as claimed in claim 1, wherein the controller causes polling by the communication device to cease after a predetermined interval if an acknowledgement is not received from the second radio.

9. The radio as claimed in claim 1, wherein the controller is operable to cause the communication device to poll the second radio on a first channel and upon receiving an acknowledgement from the second radio, to negotiate a second channel for transmission of the stored message.

10. A marine VHF radio, comprising:
a memory for storing a voice mail message suitable for transmission to a second marine VHF radio;
a communication device for transmitting and receiving radio communications; and
a controller coupled to the memory and communication device, the controller being operable to cause the communication device to poll the second radio by initiating a DSC individual call and to transmit the stored message to the second radio upon receiving an acknowledgement from the second radio to the poll.

11. The marine VHF radio as claimed in claim 10, further comprising a user interface for receiving a voice message, the controller being operable for storing the voice message to the memory as the voice mail message.

12. The marine VHF radio as claimed in claim 10, further comprising an input device for receiving the input of the Maritime Mobile Service Identity number for identifying the second marine VHF radio.

13. The marine VHF radio as claimed in claim 10, wherein the controller causes the communication device to poll of the second radio periodically.

14. The marine VHF radio as claimed in claim 10, wherein the controller causes the communication device to poll the second radio randomly.

15. The marine VHF radio as claimed in claim 10, wherein the controller causes polling by the communication device to cease after a predetermined interval if an acknowledgement is not received from the second radio.

16. The marine VHF radio as claimed in claim 10, wherein the controller is operable to cause the communication device to poll the second radio on a first channel and upon receiving an acknowledgement from the second radio, to negotiate a second channel for transmission of the stored message.

17. A method for delivering a message using a marine VHS radio, comprising:
receiving and storing the message to a memory, the message being suitable for transmission to a second marine VHF radio;
polling the marine radio by initiating a DSC individual call to the second marine radio; and
transmitting the stored message to the marine radio upon receiving an acknowledgement from the second marine radio.

18. The method as claimed in claim 17, wherein the message comprises a voice mail message.

19. The method as claimed in claim 17, further comprising receiving the input of a Maritime Mobile Service Identity number for identifying the second marine radio.

20. The method as claimed in claim 17, wherein polling of the second marine VHS radio is performed periodically.

21. The method as claimed in claim 17, wherein polling of the second marine VHS radio is performed randomly.

22. The method as claimed in claim 17, wherein polling ceases after a predetermined interval if an acknowledgement is not received from the second marine radio.

23. The marine radio as claimed in claim 17, comprising polling the second marine VHF radio on a first VHF channel, and, upon receiving an acknowledgement from the second marine radio, negotiating a second marine VHF channel for transmission of the stored message.
